(19) United States
(12) Patent Application Publication
(10) Pub. No.: US 2013/0177881 A1
(43) Pub. Date: Jul. 11, 2013

(54) Didactic tool for learning multiplication

(71) Applicant: Ariane Watkins, Marina del Rey, CA (US)

(72) Inventor: Ariane Watkins, Marina del Rey, CA (US)

(21) Appl. No.: 13/736,990

(22) Filed: Jan. 9, 2013

Related U.S. Application Data
(60) Provisional application No. 61/631,753, filed on Jan. 11, 2012.

(51) Int. Cl. G09B 19/02

(52) U.S. Cl. CPC G09B 19/02
USPC 434/193

(57) ABSTRACT

A tool, for teaching and learning multiplication includes two strips. The first strip has numbers set down in sequence from left to right in order of increasing value with each subsequent number increasing in value by adding the first number to the immediately preceding number in the sequence. The second strip is a filter, which when overlain on the first strip blocks out a repeating fixed quantity of the numbers to leave a visible second sequence such that any visible number in the visible second sequence is a fixed number additive to an immediately preceding blocked-out number. This arrangement means that any selected number in the visible second sequence is the product of the filter number times a counted position from the left of the selected number. The tool is preferably assembled so that there are numerous strips in a set that have a pivotal connection.

### CROSS-REFERENCE TO RELATED APPLICATION

This application claims the benefit of U.S. Provisional Application No. 61/631,753, filed 11-Jan.-2012, which is hereby incorporated by reference herein.

### TECHNICAL FIELD

In the field of education and demonstration, a tool to aid in teaching and learning of multiplication.

### BACKGROUND ART

According to experts in the field, most gifted children are stronger at math reasoning than calculation. Children often hate the drill and practice required to learn math facts, and many fall somewhat behind when learning their multiplication tables. Most children would benefit from strategies to make learning more fun and considerably quicker.

Student learning can be paradoxical in that children can often accomplish complex tasks, but seem to have difficulty mastering what adults consider to be simple ones. Many parents are heard to say, “for my child, what is difficult is easy, and what is easy is difficult.” Despite barriers felt by children of this sort, teachers often insist that such children master easier concepts before proceeding to more difficult ones (e.g., mastering math facts before tackling more complex math reasoning). This can cause extreme anxiety for the child.

Traditional tools like flash cards, timed tests and rote memorization techniques are often used with the expectation that repetitive, activity, even though tedious, will aid in learning. Yet, such existing methods often fail to stimulate the learning process that might otherwise be promoted by engaging a student's attention with a tool that also promotes pattern recognition and number sequences.

### SUMMARY OF INVENTION

A tool is disclosed that is useful for teaching and learning multiplication. The tool includes a first strip, on the order of a ruler used by children in school. Like a ruler, the first strip has numbers that are set down from left to right in order of increasing value. These numbers are important because they are functionally related to the operability of the tool. The numbers on the first strip are a sequence starting with a first number. The first number for example may be a 2 or a 3, or a 4, etc. After the first number, each subsequent number in the sequence increases in value by adding the first number to the immediately preceding number in the sequence. For example, for a first number of 2 on a “2”-Line first strip, the 2 would be followed by 4, 6, 8 10, etc.

The tool next includes a second strip, which is a filter. When the second strip overlays the first strip, the filter blocks out a repeating fixed quantity of the numbers in the first sequence to leave a visible second sequence. For example a “4” filter overlain on the “2” first strip would have a structure that leaves visible the 4, 8, 12, 16, 20, etc, with each visible number increasing by 4 over the previous number.

Thus, as a general matter for the first strips, any visible number in the visible second sequence is a fixed number additive to an immediately preceding blocked-out number from the first sequence. For this to occur in the example, the 4 filter would block out the 2, 6, 8, 10, 14, 18, etc. on the “2” first strip. This arrangement means that any selected number in the visible second sequence is the product of the filter number times a counted position from the left of the selected number.

The tool may be assembled so that there are numerous strips in a set. If just two strips are involved in a set, they would be preferably connected using pivotal connection between the first strip and the second strip. The pivotal connection would enable rotation of the second strip with respect to the first string.

In one embodiment, the second strip is in the form of a comb, the comb having teeth. The teeth form the filtering structure which, when overlaid on the first strip, block out numbers.

In another embodiment, the filter is a non-transparent material defining apertures through which the visible second sequence is made visible.

### Technical Problem

There is an unmet need for simple multiplication instruction tool that combines basic counting skills with visual and tactile stimuli to promote learning multiplication tables while actually solving multiplication problems in an intuitive way. Many children learn best when information is presented through a combination of reasoning, employing basic skills like counting, and touching a tool. By enabling children to hold and manipulate a multiplication instruction tool that requires recognition of the factors of a multiplication problem and then utilizing simple counting skills to find the product, it can become a fun and intuitive means for actually learning. With the notable exception of the abacus, no simple multiplication learning tool is readily available for teaching multiplication. The preferred embodiments combine manual manipulation and counting in a tool that can entertain children while helping them learn tedious multiplication factors and products.

It has been found that mathematically precocious students are significantly more likely to retain science and mathematics content accurately when it has been presented two to three times faster than the “normal” pace of a traditional mixed-ability class.

Worksheets, flashcards, drilling in the classroom, and more worksheets can cause youngsters to shut down and start to hate math or cause them to develop math anxiety at such an early age. Yet, flash cards continue to be the primary teaching tool for math facts.

Studies show that timed tests are a direct result of early onset math anxiety for students, starting as early as 1st Grade. It is well known that timed tests can cause severe math anxiety as early as the 1st Grade, resulting in long-term adverse math competency.

Dating back to the 19th Century, flashcards and rote memorization tools still have a place in education, but are not the only solution because the tedium perceived by many students, who have become practiced in instant computer response, causing them to resist straightforward rote memorization. This bodes ill for the future of science and technology because knowing math facts is a necessary skill and it all starts with learning to love math, or at least not hating it!

The first years of elementary school are critical for learning basic mathematical skills. Yet until recently the dominant view among educators and researchers alike was that math anxiety only arose in the context of complex mathematics (e.g. algebra) and thus was not present in young children. Not only do children as young as first grade report varying levels of anxiety about math, which is inversely related to their math achievement, but this anxiety is also associated with a distinct pattern of neural activity in brain regions associated with negative emotions and numerical computations.

It is acknowledged that even gifted students are significantly more likely to forget or mislearn science and mathematics content when they are forced to review and drill it more than two to three times. In other words, the constant repetition of the regular classroom, so necessary for mastery among the general population, is actually detrimental to long term storage and retrieval of technical content of gifted students.

Solution to Problem

The solution is a tool that uses an object, herein termed a first strip, with a printed number sequence in combination with a filter instrument. The printed number sequence is a sequence of numbers (for example; 2, 4, 6, 8, 10 . . . etc., and/or 3, 6, 9, 12 . . . etc.) printed onto the first strip. Additionally, the term filter is intended to mean any device or group of devices that cover and/or make specific numbers on the first strip non-viewable while making others viewable.

The didactic tool portrays various relationships between numbers by multiple means. For example, to obtain an answer to the question 9 times 4, a user simply uses the “3” Line as the first strip with the second strip being a 9″ filter. Then, the user simply counts 4 visible values to get 36. The user doesn't only see the number 36, but rather sees other multiples of 9 as well (i.e. 9, 18, 27, 45, etc.). Also, by using the tool, a user can come to understand the relationship 9 has with 3, and even the number 6 because of the manner in which the number lines can be color coded and grouped.

### Advantageous Effects of Invention

The didactic tool, or simply the tool, explained herein helps make learning multiplication easier by replacing the rote memorization of math facts with, preferably, a manually manipulated tool that demonstrates and teaches the relationship between various integers and their multiples.

Repetition of multiplication problems is made fun and entertaining by combining manual manipulation of the strips with counting. A mastery of the tool facilitates memorization of the answer to a multiplication problem while seeing larger mathematical relationships of numbers. The tool enhances the chance for number pattern recognition, which is a key to success in mathematics.

The tool is easily manipulated by children for a fast solution to a simple multiplication problem. The tool is useful in teaching children how to multiply and its operability is exemplified by the slogan; “If you can count, you can multiply.” The tool helps children to develop an insight for math rather than just forcing the child into basic, boring, rote-memorization.

Presently, a major alternative method is in the use of a calculator, which provides answers but does not provide insight into the relationships between numbers. It is believed that for many children, gifted or not, an understanding of the relationship between numbers gained both visually and physically through use of the didactic tool will lead to better retention of multiplication answers than is possible by either rote memorization or use of calculators. The tool helps children to gain number sense and computational fluency.

The tool will help bolster basic numerical and spatial processing skills and will help to reduce the likelihood of developing math anxiety. This tool enables a whole new way to learn multiplication math facts, rather than forcing children to sit and memorize them. The didactic tool enables children to visualize the patterns and sequences of numbers and helps it all make sense, rather than just be forced to memorize and regurgitate numbers. This advantage is important for students because it enables them to advance quickly to deeper math concepts rather than being held hostage with math fact boredom.

### BRIEF DESCRIPTION OF DRAWINGS

The drawings illustrate preferred embodiments of the didactic tool for learning multiplication. The reference numbers in the drawings are used consistently throughout. New reference numbers in FIG. 2 are given the 200 series numbers. Similarly, new reference numbers in each succeeding drawing are given a corresponding series number beginning with the figure number.

FIG. 1 is a plan view of a first strip and two types of filters used in the tool.

FIG. 2 is a plan view of two types of strips used in the tool, including a first strip designated a “2” Line and three second strips designated “4” Filter, “6” Filter and “8” Filter.

FIG. 3 is a plan view of two types of strips used in the tool, including two first strips designated “3” Line and a “7” Line and two second strips designated “6” Filter and “9” Filter.

FIG. 4 is a plan view of two types of strips used in the tool that are connected together in a pivotal arrangement.

### DESCRIPTION OF EMBODIMENTS

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and structural, and operational changes may be made, without departing from the scope of the present invention.

What is described herein is a tool for teaching and learning multiplication. Users are expected to be teachers and child students in the process of understanding and learning multiplication tables. The tool may be easily expanded for use in learning division by application of the principles described herein.

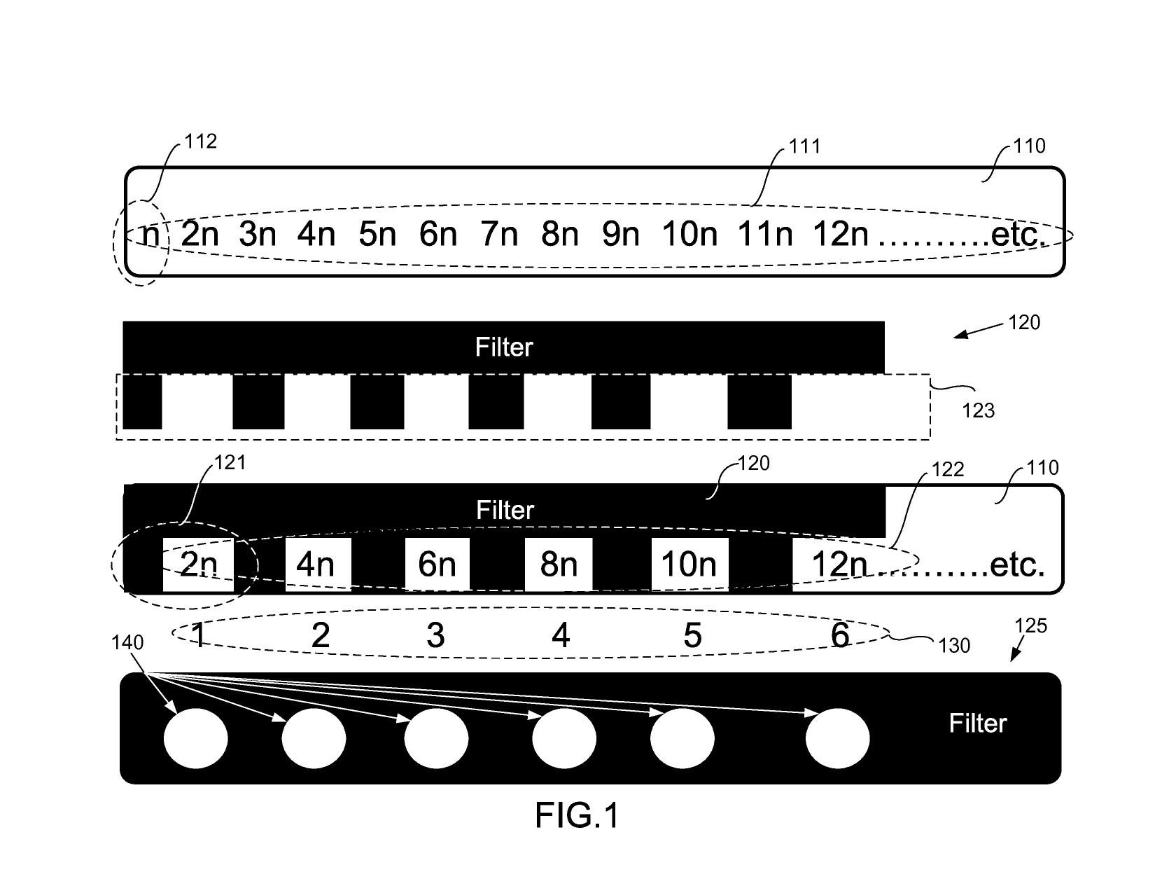

The tool includes a set of strips. The minimum number of strips in the set of strips is 2. As shown in FIG. 1, there is a first strip (110) and a second strip (120), but the set of strips may include many more strips as desired.

In exemplary embodiments, a group of different first strips are printed on something much like a ruler, although the physical embodiment of the first strips is not limited to any specific form factor. In a particular embodiment, the “first strip” may also be referred to as a “Line” preceded by the first number on that first strip. For example, when the first number is a “2,” the first strip may be referred to as a “2” Line. Generally, a preferable strip, whether a first strip (110) or a second strip (120), is about two-inches wide by about 12-inches long and about a sixteenth to an eighth of an inch in thickness.

The term “strip” is used herein in “first strip” and “second strip” designates any structure that permits the layout of numbers and filters as discussed herein.

A filter or group of filters might also be constructed from something much like a ruler, with a sequence of cut-outs or windows employed such that the result that occurs when a filter is placed over a first strip (110), certain numbers on the first strip (110) are viewable and other numbers on the first strip (110) are not viewable.

The second strip (120) is also known as a filter because of its function in filtering out numbers on the first strip (110). The term “second strip” is a more general term and may include other components and serve other functions than a “filter.” However, as used henceforth herein the terms “second strip” and “filter” are used interchangeably.

FIG. 1 is a plan view of the first strip (110) and two types of second strips or filters used in the tool: a comb-type filter, shown as second strip (120); and an aperture-type filter (125). The apertures (140) shown are circular, but any shaped aperture, having the functionality and serving the purpose set forth herein, may be used.

The set of strips includes a first strip (110) having indicia comprising numbers.

The numbers are set down from left to right in order of increasing absolute value. The numbers constitute a first sequence (111) starting with a first number (112), n. Each subsequent number after the first number (112) in the first sequence (111) increases in absolute value by n over an immediately previous number in the first sequence (111). The absolute value is used because the sequence may be composed of negative numbers, which if absolute value were not used, would technically be decreasing in value by n over the immediately previous number in the first sequence (111). Referring to the absolute value avoids having to create a more complicated explanation.

As noted, the second strip (120) comprises a filter which when said second strip (120) overlays the first strip (110), the filter blocks out a repeating fixed quantity of the numbers in the first sequence (111) to leave a visible second sequence (122). The first visible number (121) in the visible second sequence (122) defines a filter number, (also known as the first visible number (121)).

Any visible number in the visible second sequence (122) is a fixed number additive to an immediately preceding blocked-out number from the first sequence (111);

Any selected number in the visible second sequence (122) is the product of the filter number (also known as the first visible number (121)) times a counted position (130) from the left of the selected number.

The tool may be used with separated strips that are combined, as needed. Preferably, a variety of strips are organized together so that they can be rotated so as to combine any combination of first strips and second strips. For the embodiment with two strips, there is preferably a pivotal connection (420) between the first strip (110) and the second strip (120). The pivotal connection (420) enables rotation of the second strip (120) with respect to the first strip (110).

The second strip (120) is a filter that is, preferably, in the form of a comb. The comb includes teeth (123) that are the structure that covers or filters some of the numbers in the first strip (110). The teeth (123) form the filter.

The second strip (120) may alternatively be made of a non-transparent material, which defines apertures (140) through which the visible second sequence (122) is made visible. The apertures may take any shape that enables viewing the visible second sequence (122), such as holes defined by an edge that is circular, square, triangular or irregular.

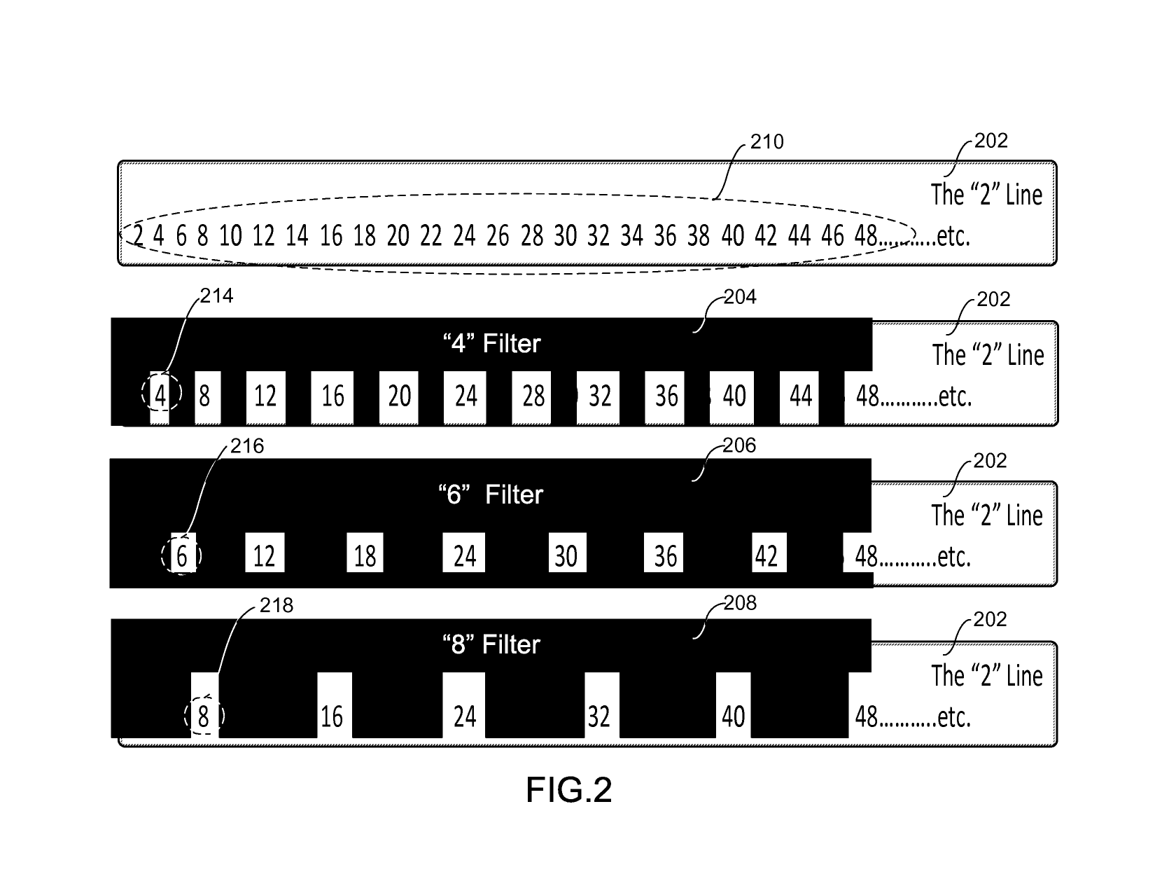

FIG. 2 illustrates an example of the first strip (110) using actual numbers: The “2” Line (202) is a first strip (110) wherein the first sequence (111) is “2” line sequence (210). The “2” line sequence (210) is a series beginning with the number 2 and followed by 2, 4, 6, 8, 10, 12, 14, 16, 18, 20, 22, 24, 26, 28, 30, 32, 34, 36, 38, 40, 42, etc. The sequence may be extended as long as desired. Thus, as seen in this example, the numbers comprising the “2” line sequence (210) start with a first number, 2, with each subsequent number in the “2” line sequence (210) increasing in absolute value by 2 over an immediately previous number in the “2” line sequence (210).

In use, it is anticipated that it would be preferable to include written instructions on one or more of the filters, for example, on the “4” Filter (204), the “6” Filter and the “8” Filter (208), to instruct the user to place each filter over the first strip (110), for example place the “6” Filter over The “2” Line (202). As an added “visual clue,” the first strip (110) may be shaped or color-coded to create distinct “visual groupings,” for example, so that the 2/4/8 groupings are yellow/orange/red and the 3/6/9 groupings are blue, light blue, green.” In this manner, the entire tool design could serve to reinforce logical numeric groupings that highlight the mathematical relationships between numbers—not just provide a fun and easy means to learning the answer.

FIG. 2 also illustrates three second strips: a “4” Filter (204), a “6” Filter (206) and an “8” Filter (208). The “4” Filter (204) and the “8” Filter (208) are comb-type filters and the “6” Filter (206) is an aperture-type filter. The number 4 (214) on “4” Filter (204) is its first visible number (121). The number 6 (216) on the “6” Filter is its first visible number (121). The number 8 (218) on the “8” Filter is its first visible number (121).

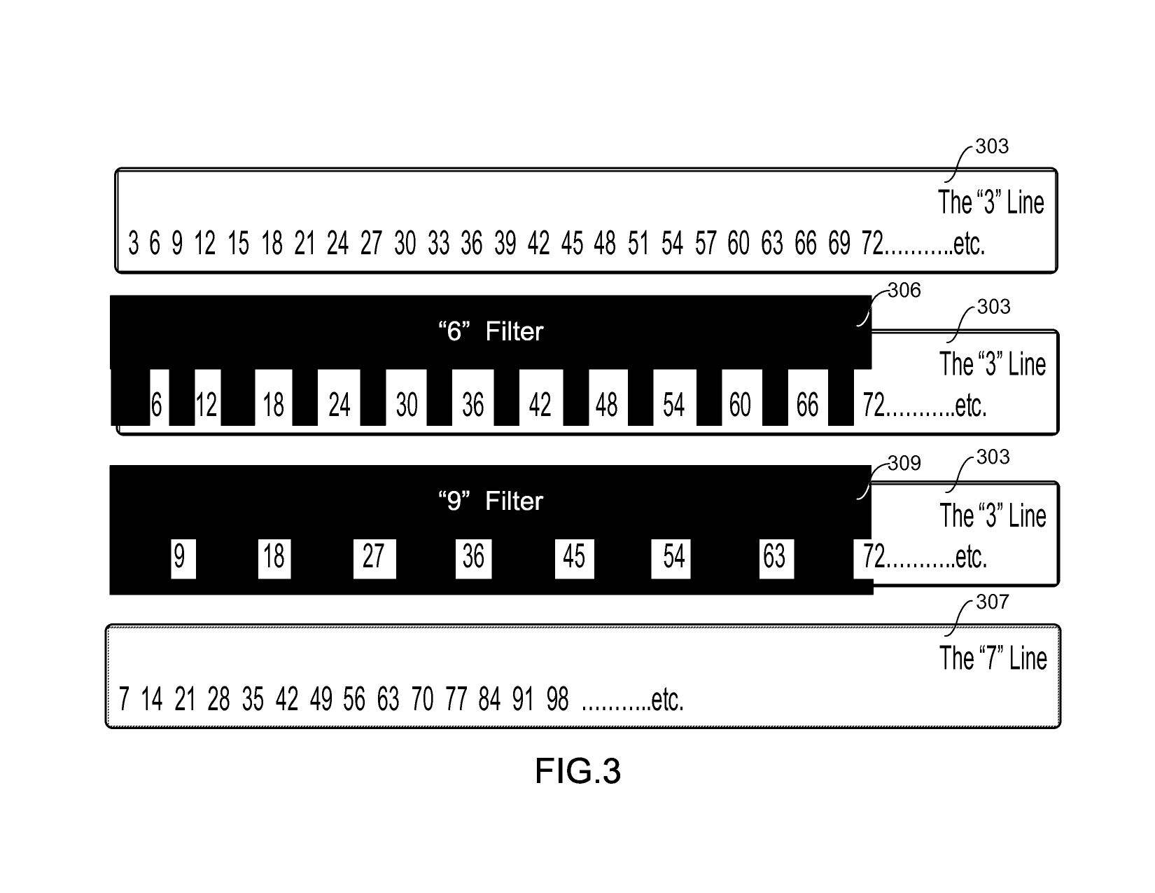

FIG. 3 is a plan view of two first strips designated The “3” Line (303) and The “7” Line (307) and two second strips designated “6” Filter (306) and “9” Filter (309). When viewed in the context of FIG. 1, which displays the general rule, The “3” Line (303) is a first strip (110). It begins with its first number (112), which is the number 3. The “3” Line comprises a first sequence (111), which progresses from left to right, each number in The “3” Line's first sequence increases by 3 over the immediately previous number in its first sequence (111).

Similarly, The “7” Line (307) is a first strip (110). It begins with its first number (112), which is The number 7. The “7” Line comprises a first sequence (111), which progresses from left to right, each number in The “7” Line's first sequence increases by 7 over the immediately previous number in its first sequence (111).

Viewing the exemplary FIG. 3 embodiment in the context of the general rule illustrated in FIG. 1, the two filters shown in FIG. 3 are the “6” Filter (306) and the “9” Filter (309).

The “6” Filter (306) is a comb-type filter, which when placed over The “3” Line (303) has a visible second sequence (122) beginning with the number 6 as its first visible number (121) and each of the following numbers in the visible second sequence (122) increases by 6 over its immediately previous number in the visible second sequence (122).

The “9” Filter (309) is an aperture-type filter, which when placed over The “3” Line (303) has a visible second sequence (122) beginning with the number 9 as its first visible number (121) and each of the following numbers in the visible second sequence (122) increases by 9 over its immediately previous number in the visible second sequence (122).

In operation, and looking at the tool in FIG. 3 that combines The “3” Line (303) with the “6” Filter (306), a student would solve the multiplication problem “what is the product of 6 times 3 by counting to the third visible number in the visible second sequence (122), which is 18. Similarly, looking at the combination of The “3” Line (303) and the “9” Filter (309), the student would solve the problem “what is the product of 9 and 4, by counting to the fourth visible number in the visible second sequence (122), revealing the product 36.

The pairings of first strip and second strip in the examples are not intended to be limiting. For example, the best combination for the “6” Filter and the “9” Filter are anticipated to be with the “3” Line.

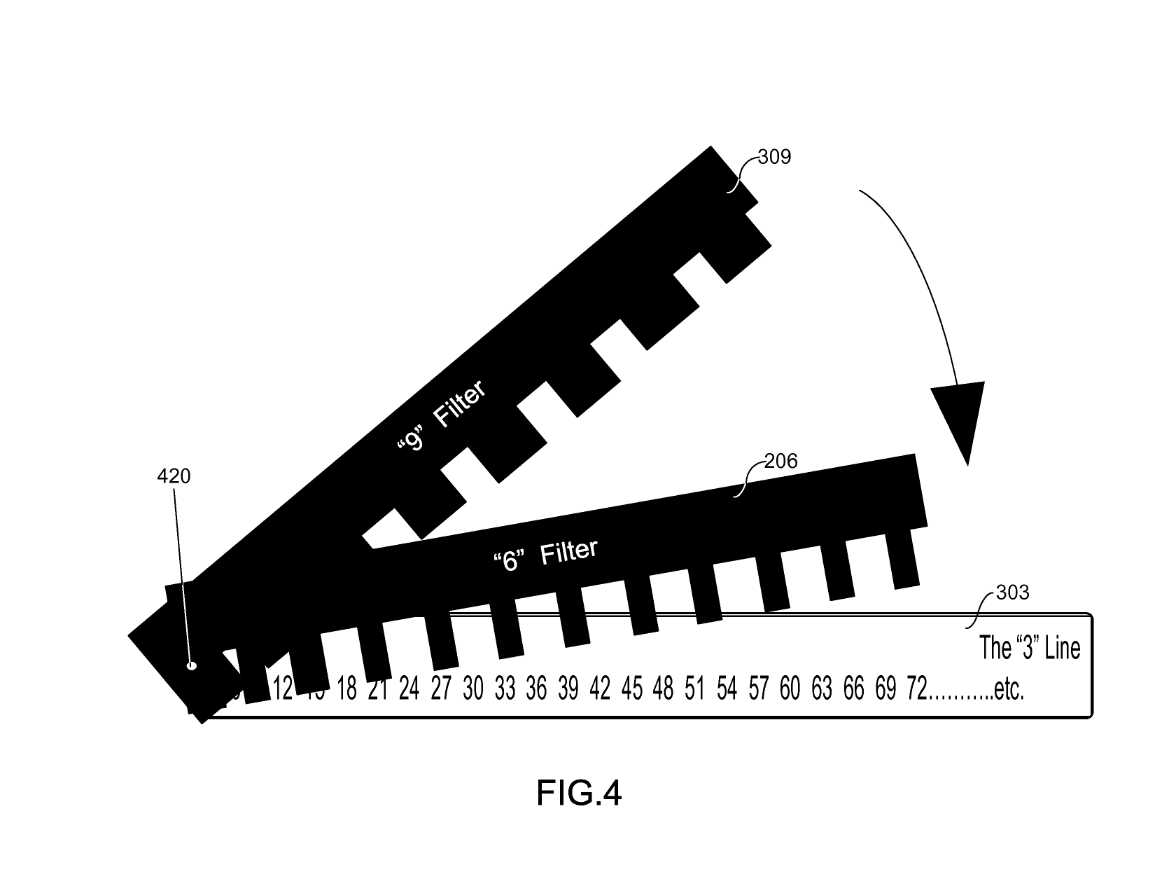

FIG. 4 is a plan view of two types of two second strips used pivotally connected to one first strip. The first strip is The “3” Line (303). The two second strips are The “6” Filter (306) and The “9” Filter (309). The pivotal connection (420) enables individualized rotation of the The “6” Filter (306) and The “9” Filter (309) over The “3” Line (303). The pivotal connection (420), which may, for example, be a simple riveted connection, permits either The “6” Filter (306) or the “9” Filter (309) to be easily rotated so that it overlays The “3” Line (303). Thus, either of these filters can be easily placed over the first strip, The “3” Line (303) in this example, such that the filter always blocks out the same repeating fixed quantity of the numbers on The “3” Line (303), and produces the same visible second sequence (122) with respect to the filter being used. In like manner, numerous filters and first strips can be assembled to provide a panoply of potential combinations.

### EXAMPLES

One exemplary embodiment of the didactic tool is described as follows. 6, 8, 10 . . . etc. all the way until 100 (multiples of two); The “3” Line being a first strip (110), comprising the numbers: 3, 6, 9, 12, . . . etc., all the way until 102 (multiples of three); The “5” Line being a first strip (110), comprising the numbers: 5, 10, 15, 20 . . . etc., all the way until 50 (multiples of five); and The “7” Line, being a first strip (110), comprising the numbers: 7, 14, 21, 28 . . . etc., all the way until 70 (multiples of seven).

Filters: a “4” Filter; a “6” Filter; an “8” Filter; and a “9” Filter. The filters are designed to overlay The “2” Line.

When overlain, the “4” Filter blocks, or covers up, all numbers on The “2” Line hat are not multiples of four and also only makes viewable, or displays, multiples of four.

When overlain, the “6” Filter blocks, or covers up, all numbers on The “2” Line that are not multiples of six and also only makes viewable, or displays, multiples of six.

When overlain, the “8” Filter blocks , or covers up, all numbers on The “2” Line that are not multiples of eight and also only makes viewable, or displays, multiples of eight.

When overlain, the “9” Filter blocks , or covers up, all numbers on The “3” Line that are not multiples of nine and also only makes viewable, or displays, multiples of nine.

When the “9” Filter overlays The “3” Line, only multiples of nine are viewable. Similarly, and as an alternative to having the “6” Filter overlay The “2” Line, the “6” Filter could overlay The “3” Line such that only multiples of six are viewable.

Once a first strip (110) and a filter are overlain, computation is performed by manually counting along the applicable first strip. So that, if multiplying four times eight, either the “8” Filter or the “4” Filter is placed over The “2” Line. When the “8” Filter is placed over The “2” Line, the sequence of numbers viewable is 8, 16, 24, 32, 40, 48, etc. By counting out to the fourth number (8×4) viewable on the filtered first strip, the answer is viewable as 32.

In the case of multiples of five and seven, no filters are required in association with The “5” Line or The “7” Line. For example, if multiplying four times five, users would simply count out to the fourth value on The “5” Line (5, 10, 15, 20) to deduce that the answer is 20.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

### INDUSTRIAL APPLICABILITY

The invention has application to the instructional tool industry.

What is claimed is:

1. A tool for teaching and learning multiplication, the tool comprising a set of strips, the set of strips comprising:
a first strip having indicia comprising numbers, the numbers are set down from left to right in order of increasing absolute value, the numbers comprising a first sequence starting with a first number, n, with each subsequent number in the first sequence increasing in absolute value by n over an immediately previous number in the first sequence; and
a second strip comprising a filter which when said second strip overlays the first strip, the filter blocks out a repeating fixed quantity of the numbers in the first sequence to leave a visible second sequence, with a first visible number in the visible second sequence defining a filter number.
wherein any visible number in the visible second sequence is a fixed number additive to an immediately preceding blocked-out number from the first sequence; and
wherein any selected number in the visible second sequence is the product of the filter number times a counted position from the left of the selected number.

2. The tool of claim 1, further comprising a pivotal connection between the first strip and the second strip, said pivotal connection enabling rotation of the second strip with respect to the first strip such that the filter always blocks out the same repeating fixed quantity of the numbers.

3. The tool of claim 1, wherein the second strip is comb-shaped, the second strip comprising teeth and said teeth forming the filter.

4. The tool of claim 1, wherein the filter is a non-transparent material defining apertures through which the visible second sequence is made visible.
